(19) United States
(12) Patent Application Publication
(10) Pub. No.: US 2026/0267971 A1
(43) Pub. Date: Sep. 10, 2026

(54) TECHNIQUES FOR MITIGATING RANSOMWARE ATTACKS IN A COMPUTER ENVIRONMENT

(71) Applicant: Rapid7, Inc., Boston, MA (US)

(72) Inventors: Natalie Zargarov, Tel-Aviv (IL); Erez Breiman, Tel-Aviv (IL); Denis Kamanovsky, Ram At-Gan (IL); Eduard Bobritsky, Yahud-Monosson (IL)

(73) Assignee: Rapid7, Inc., Boston, MA (US)

(21) Appl. No.: 19/329,333

(22) Filed: Sep. 15, 2025

(30) Foreign Application Priority Data
Mar. 4, 2025 (IL) 319369

(51) Int. Cl. G06F 21/55; G06F 21/54; G06F 21/56

(52) U.S. Cl. CPC G06F 21/554; G06F 21/54; G06F 21/566

(57) ABSTRACT

Techniques for mitigating ransomware attacks in a computer environment, including: using a computer hardware processor to perform: identifying an event in the computer environment indicative of a request from a computer process to access metadata related to one or more file system objects stored in the computer environment; capturing the event, such that an operating system of the computer environment may not respond; determining whether the event is malicious based on one or more characteristics of the event; when it is determined the event is not malicious: releasing the event so the operating system may respond; and when it is determined the event is malicious: generating simulated metadata related to the one or more file system objects, the simulated metadata different from the metadata of the one or more file system objects; and returning the simulated metadata responsive to the request.

### BACKGROUND

Today, cybercrimes are increasing in frequency, with modern computing environments being susceptible to various types of cyberattacks. One common type of cyberattack is a ransomware attack. Ransomware is a type of malware that restricts access to the infected computer system in some way, and demands that the user pay a ransom to the malware operators to remove the restriction. Some forms of ransomware systematically encrypt files, which become difficult or impossible to decrypt without paying the ransom for the encryption key, while some may simply lock the system and display messages intended to coax the user into paying. Ransomware attacks will typically provide an encryption key or otherwise allow users to regain access to their computer environments when the ransom is paid.

As with other forms of malware, security software might not detect a ransomware attack until the attack is already underway. This is particularly so for ransomware attacks, as these attacks may already have accessed and started to encrypt file system objects within a computer environment before being detected.

If an attack is suspected or detected in its early stages, immediate removal of the malware before it has completed would stop further damage to data but would not salvage any already lost data.

### SUMMARY

Some embodiments provide for a method for mitigating malware attacks in a computer environment, the method comprising: using a computer hardware processor to perform: identifying an event in the computer environment indicative of a request from a computer process to access metadata related to one or more file system objects stored in storage of the computer environment; capturing the event, such that an operating system of the computer environment is prevented from responding to the event; determining whether the event is a malicious event based on one or more characteristics of the event; when it is determined that the event is not a malicious event: releasing the event thereby allowing the operating system of the computer environment to respond to the request from the computer process; and when it is determined that the event is a malicious event: generating simulated metadata related to the one or more file system objects, the simulated metadata different from the metadata related to the one or more file system objects; and returning the simulated metadata related to the one or more file system objects responsive to the request from the computer process.

In some embodiments, the determining comprises: determining a threat score for the event based on the one or more characteristics of the event; and determining the event is a malicious event when the threat score exceeds a threshold threat score.

In some embodiments, determining the threat score comprises determining the threat score based on one or more of: timing data related to the event; data related to generation of the event; and other events within the computer environment.

In some embodiments, the threat score is determined based on the timing data related to the event; and the timing data related to the event includes one or more of: a creation time of the computer process; and a frequency of file system object access requests made by the computer process.

In some embodiments, the threat score is determined based on the data related to generation of the event; and the data related to generation of the event includes one or more of: whether the computer process has memory allocated within the computer environment; whether the computer process is enumerating multiple file system objects within the computer environment; a file path of the computer process; and a signature of the computer process.

In some embodiments, determining the threat score comprises increasing the threat score from a baseline score when it is determined that: the computer process was created within 5 minutes of identifying the event; a frequency of file system object access requests made by computer process exceeds a threshold frequency; the computer process associated with the event allocates memory during its runtime; the computer process enumerates multiple file system objects without associated read or write requests; the computer process originates from a file downloaded from the Internet; the computer process originates from a temporary file; the computer process originates from an archive file; the computer process has a revoked certificate; and/or the process associated with the event is extracted from a self-extracting file.

In some embodiments, determining the threat score comprises decreasing the threat score from a baseline score when it is determined that: the computer process has a signature associated with a known source; the process associated with the event is associated with an operating system process; the process associated with the event is associated with a computer environment device process; the process associated with the event is one of a set of a user defined set of trusted processes; and/or the process associated with the event is visible to a user of the computer environment.

In some embodiments, generating the simulated metadata comprises: generating the simulated metadata by changing the requested metadata related to the file system object based on the requested metadata and/or malicious event.

In some embodiments, generating the simulated metadata comprises: determining one or more changes using: the requested metadata; request patterns of a process associated with the malicious event; and/or a location in storage of the one or more files related to the requested metadata.

In some embodiments, generating the simulated metadata comprises: generating the simulated metadata to indicate the one or more file system objects are folders, when the one or more file system objects are files within the computer environment.

In some embodiments, generating the simulated metadata comprises: generating the simulated metadata to indicate the one or more file system objects are related to operating system and/or computer environment device processes.

In some embodiments, changing the metadata to indicate the one or more file system objects are related to operating system and/or computer environment device processes is performed based on a location of the one or more file system objects in storage of the computer environment.

In some embodiments, generating the simulated metadata comprises: introducing a latency to access the requested metadata; generating the simulated metadata to indicate one or more file system objects are stored externally from the computer environment; generating the simulated metadata to indicate the one or more file system objects cannot be accessed by the computer process; generating the simulated metadata to indicate the one or more file system objects are stored in a location in memory storage not associated with the one or more file system objects; generating the simulated metadata to indicate the one or more file system objects are corrupted; and/or changing the simulated metadata to indicate storage associated with the one or more file system objects is disconnected from the computer environment.

In some embodiments, the method further comprises: identifying one or more events in the computer environment associated with the malicious event; determining whether the identified events are associated with a ransomware attack; and responsive to determining the identified events are associated with a ransomware attack, performing one or more cybersecurity actions to address the ransomware attack.

In some embodiments, determining whether the identified events are associated with a ransomware attack comprises: determining a ransomware score based on one or more of: behavior patterns, memory use, or a source of the identified events; and determining the identified events are associated with a ransomware attack when the ransomware score exceeds a threshold score. In some embodiments, performing the one or more cybersecurity actions comprises performing one or more of: isolating a process associated with the ransomware attack; terminating the process associated with the ransomware attack; or analyzing actions performed by the process associated with the ransomware attack.

Some embodiments provide for a system for mitigating malware attacks in a computer environment, the system comprising: at least one computer hardware processor; and at least one non-transitory computer-readable storage medium storing processor-executable instructions that, when executed by the at least one computer hardware processor, causes the at least one computer hardware processor to perform a method comprising: identifying an event in the computer environment indicative of a request from a computer process to access metadata related to one or more file system objects stored in storage of the computer environment; capturing the event, such that an operating system of the computer environment is prevented from responding to the event; determining whether the event is a malicious event based on one or more characteristics of the event; when it is determined that the event is not a malicious event: releasing the event thereby allowing the operating system of the computer environment to respond to the request from the computer process; and when it is determined that the event is a malicious event: generating simulated metadata related to the one or more file system objects, the simulated metadata different from the metadata related to the one or more file system objects; and returning the simulated metadata related to the one or more file system objects responsive to the request from the computer process.

In some embodiments, the determining comprises: determining a threat score for the event based on the one or more characteristics of the event; and determining the event is a malicious event when the threat score exceeds a threshold threat score.

In some embodiments, generating the simulated metadata comprises: generating the simulated metadata by changing the requested metadata related to the file system object based on aspects of the requested metadata and/or malicious event.

Some embodiments provide for at least one non-transitory computer-readable storage medium storing processor-executable instructions that, when executed by at least one computer hardware processor, causes the at least one computer hardware processor to perform a method for mitigating malware attacks in a computer environment, the method comprising: identifying an event in the computer environment indicative of a request from a computer process to access metadata related to one or more file system objects stored in storage of the computer environment; capturing the event, such that an operating system of the computer environment is prevented from responding to the event; determining whether the event is a malicious event based on one or more characteristics of the event; when it is determined that the event is not a malicious event: releasing the event thereby allowing the operating system of the computer environment to respond to the request from the computer process; and when it is determined that the event is a malicious event: generating simulated metadata related to the one or more file system objects, the simulated metadata different from the metadata related to the one or more file system objects; and returning the simulated metadata related to the one or more file system objects responsive to the request from the computer process.

Some embodiments provide for a method for mitigating ransomware attacks in a computer environment, the method comprising: using a computer hardware processor to perform: responsive to detecting, by an information security system executing in the computer environment, an event related to exploring file system objects in the computer environment and determined to be likely associated with a ransomware process executing in the computer environment: spoofing file system object metadata for one or more file system objects to prevent the ransomware process from encrypting the one or more file system objects.

In some embodiments, the one or more file system objects include a first content file; and spoofing the metadata for the one or more file system objects comprises spoofing the metadata for the first content file by generating metadata that indicates the content file to be a folder rather than a content file.

In some embodiments, the one or more file system objects include a first file system object; and spoofing the metadata for the one or more file system objects comprises spoofing the metadata for the first file system object by generating metadata for the first file system object that indicates the first file system object is offline.

In some embodiments, the one or more file system objects include a first file system object stored in a system related file path; and spoofing the metadata for the one or more file system objects comprises spoofing the metadata for the first file system object by generating metadata for the first file system object that indicates the first file system object is a system file.

In some embodiments, the one or more file system objects include a first content file; and spoofing the metadata for the one or more file system objects comprises spoofing the metadata for the first content file by generating metadata for the first content file including a checksum indicating the first content file is corrupted.

In some embodiments, the method further comprises: returning the spoofed metadata responsive to the event with a predetermined latency.

In some embodiments, the method further comprises: responsive to the detecting: capturing the event such that an operating system of the computer environment is prevented from responding to the event.

Some embodiments provide for a system for mitigating ransomware attacks in a computer environment, the system comprising: at least one computer hardware processor; and at least one non-transitory computer-readable storage medium storing processor-executable instructions that, when executed by the at least one computer hardware processor, causes the at least one computer hardware processor to perform a method comprising: responsive to detecting, by an information security system executing in the computer environment, an event related to exploring file system objects in the computer environment and determined to be likely associated with a ransomware process executing in the computer environment: spoofing file system object metadata for one or more file system objects to prevent the ransomware process from encrypting the one or more file system objects.

In some embodiments, the one or more file system objects include a first content file; and spoofing the metadata for the one or more file system objects comprises spoofing the metadata for the first content file by generating metadata that indicates the content file to be a folder rather than a content file.

In some embodiments, the one or more file system objects include a first file system object; and spoofing the metadata for the one or more file system objects comprises spoofing the metadata for the first file system object by generating metadata for the first file system object that indicates the first file system object is offline.

In some embodiments, the one or more file system objects include a first file system object stored in a system related file path; and spoofing the metadata for the one or more file system objects comprises spoofing the metadata for the first file system object by generating metadata for the first file system object that indicates the first file system object is a system file.

In some embodiments, the one or more file system objects include a first content file; and spoofing the metadata for the one or more file system objects comprises spoofing the metadata for the first content file by generating metadata for the first content file including a checksum indicating the first content file is corrupted.

In some embodiments, the least one non-transitory computer-readable storage medium stores further processor-executable instructions that, when executed by the at least one computer hardware processor, causes the at least one computer hardware processor to perform: returning the spoofed metadata responsive to the event with a predetermined latency.

In some embodiments, the least one non-transitory computer-readable storage medium stores further processor-executable instructions that, when executed by the at least one computer hardware processor, causes the at least one computer hardware processor to perform: responsive to the detecting: capturing the event such that an operating system of the computer environment is prevented from responding to the event.

Some embodiments provide for at least one non-transitory computer-readable storage medium storing processor-executable instructions that, when executed by at least one computer hardware processor, causes the at least one computer hardware processor to perform a method for mitigating ransomware attacks in a computer environment, the method comprising; using a computer hardware processor to perform: responsive to detecting, by an information security system executing in the computer environment, an event related to exploring file system objects in the computer environment and determined to be likely associated with a ransomware process executing in the computer environment: spoofing file system object metadata for one or more file system objects to prevent the ransomware process from encrypting the one or more file system objects.

In some embodiments, the one or more file system objects include a first content file; and spoofing the metadata for the one or more file system objects comprises spoofing the metadata for the first content file by generating metadata that indicates the content file to be a folder rather than a content file.

In some embodiments, the one or more file system objects include a first file system object; and spoofing the metadata for the one or more file system objects comprises spoofing the metadata for the first file system object by generating metadata for the first file system object that indicates the first file system object is offline.

In some embodiments, the one or more file system objects include a first file system object stored in a system related file path; and spoofing the metadata for the one or more file system objects comprises spoofing the metadata for the first file system object by generating metadata for the first file system object that indicates the first file system object is a system file.

In some embodiments, the one or more file system objects include a first content file; and spoofing the metadata for the one or more file system objects comprises spoofing the metadata for the first content file by generating metadata for the first content file including a checksum indicating the first content file is corrupted.

In some embodiments, the at least one non-transitory computer-readable storage medium stores further instructions that cause the at least one computer hardware processor to perform: responsive to the detecting: capturing the event such that an operating system of the computer environment is prevented from responding to the event.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A shows an example environment in which an information security system may operate, in accordance with some embodiments of the technology described herein.

FIG. 1B shows components of an example information security system within a computer environment, in accordance with some embodiments of the technology described herein.

FIG. 2 is an example process which may be performed by a ransomware attack, as well as steps that may be used in remediating such attacks.

FIG. 3 is an example process which may be performed by an information security system to prevent ransomware attacks from accessing file system objects, in accordance with some embodiments of the technology described herein.

FIG. 4 is an example data flow which may be performed by an information security system deployed to a computer environment responsive to a non-malicious event, in accordance with some embodiments of the technology described herein.

FIG. 5A is an example data flow which may be performed by an information security system deployed to a computer environment to generate simulated metadata indicating a file system object is a folder, responsive to a malicious event, in accordance with some embodiments of the technology described herein.

FIG. 5B is an example data flow which may be performed by an information security system deployed to a computer environment to generate simulated metadata indicating a file system object has a “system” attribute, responsive to a malicious event, in accordance with some embodiments of the technology described herein.

FIG. 6A is an example process for identifying malicious events and generating simulated metadata to return responsive to malicious events, in accordance with some embodiments of the technology described herein.

FIG. 6B is an example process for mitigating a ransomware attack, in accordance with some embodiments of the technology described herein.

FIG. 7 shows a block diagram of an exemplary computing device, in accordance with some embodiments of the technology described herein.

### DETAILED DESCRIPTION

Ransomware attacks often begin by determining a set of files within a computer environment to encrypt. The ransomware may access a location within the file storage of a computer environment, for example a folder or partition, and request metadata related to the file system objects stored in that location. Based on the metadata associated with a file system object, the ransomware determines whether to add the file system object to a list for encryption, skip the object, or perform some other action with the object.

Ransomware may select file system objects in a computer environment for encryption. File system objects may include various types of objects within a computer environment, for example, folders, system files (e.g., files related to the functioning of a computer environment or a device within a computer environment, such as executable files), and/or content files (e.g., document files, PDF files, picture files, movie files, or text files, among similar files), among other data types.

Ransomware attacks may target content files or similar file system objects for encryption because they are typically accessed by users of the computer environment frequently and are valuable to the user of the computer environment. Therefore, a user may be more likely to pay a ransom to regain access to these file system objects.

On the other hand, ransomware may skip over file system objects which take too long to access, are corrupted, are not stored locally to a computer environment, or are related to the functioning of the computer environment and/or devices of the computer environment. These files may be skipped over because they may delay the ransomware from encrypting the stored files, may not be accessible for encryption, or, such as in the case of system and/or device related files, may damage the computer environment. In the case of system and/or device related files, damaging the computer environment may prevent the ransomware attack from progressing within the environment and/or may prevent a user of the computer environment from using the computer environment.

For ransomware attacks, it is desirable to infect as many objects within a computer environment as possible to maximize the impact on the computer environment while avoiding detection. Additionally, it is important for ransomware attacks to avoid breaking a computer environment so a user of the computer of the environment can learn of the attack and be motivated to pay the ransom to decrypt or otherwise regain access to the content of their computer environment.

When encountering a folder, the ransomware may enumerate the contents of the folder to determine if the folder contains objects which should be encrypted. Ransomware does not try to encrypt the folder itself.

After determining which files to encrypt, the ransomware will proceed to access the identified file system objects and encrypt the objects, such that their content is no longer accessible to a user of the computer environment. The ransomware may use operating system based API function to access the file (e.g., NtOpenFile, NtCreateFile, CreateFile, OpenFile, fopen, etc.) and generates Read and Write instructions using API calls for requesting overwriting by writing the encrypted version of the file. The ransomware then reads the content of the file system objects in order to encrypt them. The ransomware might read one block from an object, and then immediately overwrite it with an encrypted version thereof or read the whole content of the object, encrypt it while still in the memory and then overwrite the content.

After encrypting a file system object, the ransomware may proceed to encrypt the remaining file system objects within a particular location within the file storage of the computer environment. After encrypting the objects within a particular location within the file storage, the ransomware may proceed to identify other locations within the file storage from which to identify contents to encrypt. Some ransomwares may make a list of objects to encrypt from the entire storage of a computer environment and encrypt all objects together as opposed to moving from location to location.

Conventional techniques for detecting and mitigating ransomware attacks search for signatures of ongoing ransomware attacks within a computer environment. For example, conventional techniques for detecting and mitigating ransomware attacks rely on known attack signatures, such as signatures associated with file system objects being accessed, file system objects being altered, file system objects being encrypted, and/or file system objects being deleted. Some conventional techniques for detecting and mitigating ransomware attacks additionally or alternatively rely on cumulative suspicious behaviors of processes within a computer environment to identify a ransomware attack, for example memory usage, request patterns, and/or access patterns of processes. These conventional techniques for detecting and mitigating ransomware attacks do not prevent a ransomware attack from accessing computer environment file system objects and instead can only address a ransomware attack after the ransomware attack has begun. But as discussed in above, even if ransomware attacks are identified early, that is too late because access to some file system objects within the computer environment will already have been blocked (e.g., by encryption).

Furthermore, as ransomware attacks become more sophisticated, the attacks may recognize when they have been identified or are being addressed by conventional ransomware detection and mitigation techniques. For example, some conventional ransomware detection and mitigation techniques isolate suspicious processes executing in a computer environment by directing them to a sandbox environment where their behavior is monitored to determine if they are associated with a ransomware attack. However, such conventional techniques for detecting and mitigating ransomware attacks only detect ransomware attacks only after they started and some ransomware attacks may recognize when they are in such environments and limit their behavior to avoid detection, for example by stopping encryption of file system objects. Therefore, these conventional techniques for detecting and mitigating ransomware attacks do not protect all stored file system objects during a ransomware attack and typically result in access to some stored objects being lost (e.g., through encryption of the contents).

The inventors have recognized that conventional ransomware detection and mitigation techniques may be improved by preventing ransomware attacks before they start infecting file system objects and, in particular, by preventing ransomware from accessing file system data or metadata within a computer environment. Preventing ransomware from accessing file system objects or file system object metadata within a computer environment, will ensure users retain access to file system objects within the computer environment, while still allowing the ransomware to be analyzed and identified for remediation.

Accordingly, the inventors have developed a new technique for addressing ransomware attacks within a computer environment. The technique involves analyzing events in the computer environment and preventing the operating system of the computer environment from responding to events it determines to be associated with a ransomware attack. The techniques may involve capturing computer environment events which are related to requests for metadata related to one or more file system objects within the computer environment, such that the operating system of the computer environment may not respond to these events. Captured events may then be analyzed to determine whether the events are malicious or not. If captured events are determined not to be malicious, the operating system of the computer environment may be allowed to respond to the events. On the other hand, if captured events are determined to be malicious, simulated metadata may be generated and returned responsive to the event. For example, an event involving trying to access a file may be determined to be malicious, in which case instead of returning metadata containing information about the true nature of the file (e.g., indicating that the file is a content file such as a document, which may cause the ransomware to encrypt the file), the system may generate simulated metadata that contains false information about the nature of the file (e.g., indicating the file to be either a folder or a system file, neither of which ransomware will attempt to encrypt). The simulated metadata prevents malicious events from accessing actual file metadata within the computer environment and may allow for continued monitoring of processes related to malicious events for identification and remediation of ransomware attacks. Such techniques will prevent ransomware attacks from accessing file system object data or metadata within a computer environment while still allowing for monitoring and remediation of these attacks.

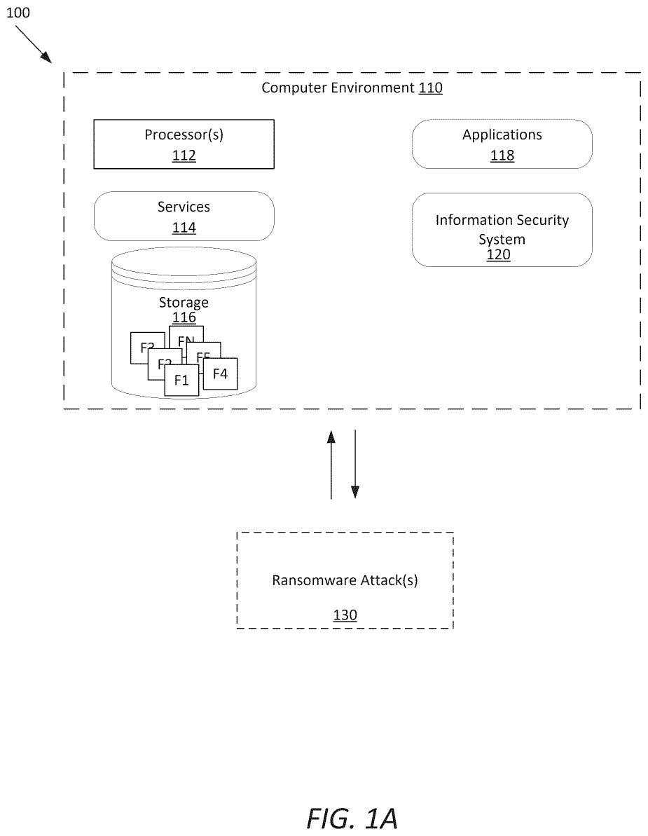

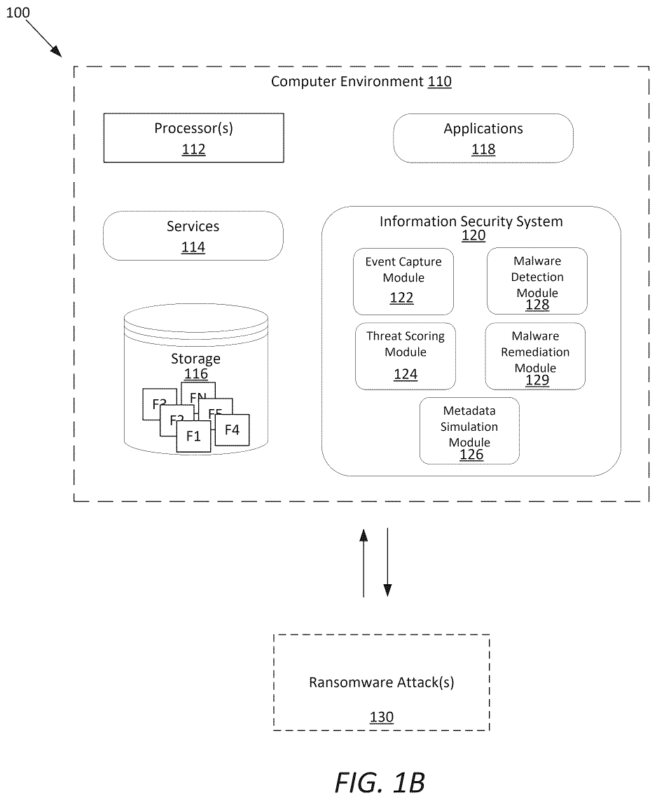

In some embodiments, the techniques described herein may be implemented via an information security system deployed to a computer environment, for example information security system 120 in computer environment 110 of FIGS. 1A-B. In some embodiments, computer environments may include individual devices such as a desktop, laptop, smartphone, server, tablet, IOT device, industry controller device or among other devices. In some embodiments, computer environments may include virtual objects, for example, a virtual container, containers, virtual storage, or among other virtual devices. In some embodiments, computer environments may include one or more interconnected devices, for example, devices connected over a network such as a cloud computing network, a local area network (LAN) or a wide area network (WAN), among other networks. In some embodiments, an information security system is external to the computer environment to which it is deployed. In some embodiments, an information security system is contained within the computer environment to which it is deployed. In some embodiments, an information security system may include one or more modules external to and one or more modules contained within the computer environment to which it is deployed.

In some embodiments, computer environments to which information security systems implementing the techniques described herein may be deployed, for example information security system 120 in computer environment 110 of FIGS. 1A-B, may include file storage for maintaining and controlling access to file system objects within the computer environment. In some embodiments, file storage may be physical data storage directly connected to the computer environment. In some embodiments, the file storage may be storage external to the computer environment and accessible through a network connection. The file storage may store file system objects including documents, office files, image files, video files, audio files, text files, application files, folders, and system files, among other object types. Processes executed within the computer environment may interact with file system objects within the file storage, for example, accessing, deleting, and/or modifying objects.

File system objects within the file storage may have accessible metadata. The metadata about file system objects may include data indicating (e.g., directly specifying) a file path of the object, a creation time of the object, a last modified time of the object, an object type, an object attribute, a size of the object, object permissions, object accessibility, object name, and/or an object checksum, among other data. Ransomware attacks may request object metadata and determine a list of file system objects to encrypt based on obtained metadata. For example, ransomware will try to determine whether a file is a content file (e.g., a document, an image, a movie, etc.) or a system file (e.g., an executable) and may determine to encrypt the former (e.g., because of its value to the user) and not the latter (e.g., to not break the operating system environment and to permit the restoration of encrypted data in return for a ransom payment).

In some embodiments, as computer processes within a computer environment interact with file system objects, events are generated within the computer environment. For example, an event may be generated within a computer environment when a computer process requests access to metadata of one or more file system objects. These events may be generated within an activity log of the computer environment and may include details related to the computer process associated with the event. For example, events may include data related to a creation time of the process, memory allocated to the process, enumeration behavior of the process, a signature of the process, a file path of the process, and/or a certificate of the process, among other data.

The inventors have recognized that the effects of ransomware attacks may be mitigated based on events generated during the attack. Accordingly, in some embodiments, an information security system may analyze events within a computer environment to identify events which may be associated with a ransomware attack. In some embodiments, a threat score is determined for events within the computer environment based on data associated with the event or computer process. In some embodiments, an event is determined to be a malicious event when the threat score for the event exceeds a threshold score.

In some embodiments, a security system may analyze all events within a computer environment to determine whether the events are malicious and/or associated with a ransomware attack. In some embodiments, a security system may analyze a subset of events within a computer environment, which are most likely to be malicious and/or associated with a ransomware attack. For example, in some embodiments, a security system may analyze events which are associated with requests to access file system objects or file system object metadata within a computer environment. The inventors have recognized that analyzing such requests allows a security system to identify a potential ransomware attack before the attack starts to encrypt files within the computer environment. Examples of such events include: in a Microsoft Windows Environment: GetFileAttributesW, FindFirstFileW, FindNextFileW, CreateFileW, ReadFile, WriteFile, DeviceloControl, NtQueryAttributesFile, NtQuery Directory File, NtCreateFile, or NtSetInformationFile; in a Linux environment: stat, Istat, fstat, scandir, open, read, write, close, ioctl, or readdir; and in a Mac Environment: stat, fstat, Istat, getattrlist, setattrlist, open read, write, opendir, readdir, getxattr, or setxattr.

In some embodiments, when it is determined that an event requires analysis, the event is captured, such that the operating system of the computer environment is prevented from responding to the event. Events may be captured via function hooking such that the event may be analyzed before a response to the event is generated. Events may additionally or alternatively be captured using filter drivers, for example bus filter drivers, lower-level filter drivers and/or upper-level filter drivers. In some embodiments, when it is determined an event does not require analysis, the event is not captured, and the operating system of the computer environment is permitted to respond to the event.

In some embodiments, a threat score is determined for the events when the events are captured for analysis. In some embodiments, a captured event is given a baseline threat score when it is captured for analysis. In some embodiments, the baseline threat score indicates an event is malicious. In some embodiments the baseline threat score indicates an event is not malicious. In some embodiments, the event is analyzed to determine whether to increase or decrease the threat score from the baseline score. In some embodiments, the threat score is increased and/or decreased by a predetermined amount based on an analysis. In some embodiments, the threat score is increased and/or decreased by a predetermined percentage based on an analysis (e.g., 5%, 10%, 20%, 25% 30%, 40%, 50%, greater than 50%, 100%, greater than 100%, etc.). In some embodiments the amount and/or percentage the threat score is increased and/or decreased may be based on how likely the event is to be malicious based on analysis of the event.

In some embodiments, the threat score for an event is increased from the baseline score when it is determined that the computer process associated with the event was created recently, for example within 1 minute of identifying the event, within 2 minutes of identifying the event, within 5 minutes of identifying the event, within 10 minutes of identifying the event, within 30 minutes of identifying the event, or between 1 and 30 minutes of identifying the event. In some embodiments, the threat score may be increased by a predetermined amount or by a predetermined percentage (e.g., 5%, 10%, 20%, 25% 30%, 40%, 50%, greater than 50%, 100%, greater than 100%, etc.). More recently created processes may raise threat scores as they are less likely to be associated with processes occurring with the regular functioning of the computer environment which often begin at startup of the environment. In some embodiments, the threat score may increase by different amounts based on the time of creation of the computer process. For example, the threat score may increase by a first amount when the computer process was created within 0-1 minute of identifying the event, by a second amount, less than the first amount, when the computer process was created within 1-2 minutes of identifying the event, and may increase by successively decreasing amounts until a specified time limit is reached (e.g., 3 minutes, 5 minutes, 10 minutes, 15 minutes, or other suitable time frames after the event). In some embodiments, the threat score may increase by a predetermined amount or by a predetermined percentage based on the creation time of the computer process and may decrease until a specified time limit is reached. For example, at the creation time of a computer process the threat score increase increased by 40% for an associated event, and this percentage increase decreases linearly to 10% over a five-minute period, after which, the threat score is not increased based on the creation time of the computer process associated with the event. In some embodiments, the threat score increase based on the creation time of the computer process may decrease linearly until the specified time limit is reached. In some embodiments, the threat score increase based on the creation time of the computer process may decrease exponentially until the specified time limit is reached.

In some embodiments, the threat score for an event is increased from the baseline score when it is determined that a frequency of file system object metadata access requests made by the computer process associated with the event exceeds a threshold frequency. In some embodiments, the threat score may be increased by a predetermined amount or by a predetermined percentage (e.g., 5%, 10%, 20%, 25% 30%, 40%, 50%, greater than 50%, 100%, greater than 100%, etc.). Examples of such requests include API calls such as FindFirstFile and/or similar requests. In some embodiments, the threshold frequency may be 1 access request per minute, 10 metadata access requests per minute, 20 metadata access requests per minute or between 10 and 50 metadata access requests per minute. In some embodiments, the threshold frequency is dependent on behavior of the computer process associated with the access requests. For example, when a computer process has not made file system object metadata access requests for a previous time period (e.g., the last minute, last 5 minutes, last 10 minutes, etc.) and begins to make multiple file system object metadata requests (e.g., 2 requests, 3 requests, 5 requests, greater than 5 requests, etc.), the threat score may be increased. In some embodiments, the threat score may increase based on the amount of file system object metadata requests made by a computer process. For example, the threat score may increase linearly from 0-20% for each successive file system object metadata request over the threshold frequency or amount. High file system object metadata access request frequencies is a common feature of ransomware attacks as they search for files to encrypt and therefore increase the threat level for events.

In some embodiments, the threat score for an event is increased from the baseline score when it is determined that the computer process associated with the event allocates memory during its runtime. The threat score may be increased by a predetermined amount or by a predetermined percentage (e.g., 5%, 10%, 20%, 30%, 40%, 50%, greater than 50%, 100%, greater than 100%, etc.). Ransomware attacks will often require memory to perform the attack and therefore processes allocating such memory are more likely to be malicious.

In some embodiments, the threat score for an event is increased from the baseline score when it is determined the computer process associated with the event enumerates multiple file system objects without associated read or write requests. In some embodiments, the threat score may be increased by a predetermined amount or by a predetermined percentage (e.g., 10%, 20%, 25% 30%, 40%, 50%, greater than 50%, 100%, greater than 100%, etc.). In some embodiments, the score increase is determined based on the amount of files system objects enumerated by the computer process. For example, the score increase may be proportional to the number and/or percentage of file system objects enumerated by the process. In one example, the threat score may be increased by a percentage that increases from 5%-30% based on the percentage of file system objects enumerated by the computer process out of a total number of protected file system objects. File enumeration without associated read/write requests is common in ransomware attacks, which often generate a list of files to encrypt before performing the encryption of the files, therefore processes with such behavior are more likely to be malicious processes.

In some embodiments, the threat score for an event is increased from the baseline score when it is determined the process associated with the event has a file path originating from an internet downloaded source. In some embodiments, the threat score may be increased by a predetermined amount or by a predetermined percentage (e.g., 5%, 10%, 20%, 25%, 30%, 40%, 50%, greater than 50%, 100%, greater than 100%, etc.). Malware is likely to be introduced to a computer environment through internet-downloaded processes and therefore such processes are more likely to be malicious processes than those not downloaded from the internet.

In some embodiments, the threat score for an event is increased from the baseline score when it is determined the process associated with the event has a file path originating from a temporary file. In some embodiments, the threat score may be increased by a predetermined amount or by a predetermined percentage (e.g., 10%, 20%, 25% 30%, 40%, 50%, greater than 50%, 100%, greater than 100%, etc.). Ransomware often executes from temporary files to limit detection, and therefore processes originating from temporary sources are more likely to be malicious processes.

In some embodiments, the threat score for an event is increased from the baseline score when it is determined the process associated with the event has a revoked certificate. In some embodiments, the threat score may be increased by a predetermined amount or by a predetermined percentage (e.g., 10%, 20%, 25% 30%, 40%, 50%, greater than 50%, 100%, greater than 100%, etc.). Certificates are used to verify the identity of a computer process to ensure the computer process is trusted to perform the specified action. A revoked certificate indicates that a computer process may not be trustworthy and therefore is more suspicious.

In some embodiments, the threat score for an event is increased from the baseline score when it is determined the computer process associated with the event has a file path originating from a self-extracting file. In some embodiments, the threat score may be increased by a predetermined amount or by a predetermined percentage (e.g., 10%, 20%, 25% 30%, 40%, 50%, greater than 50%, 100%, greater than 100%, etc.). Self-extracting files, such as self-extracting archives, allow for compressed data to be automatically executed within a computer environment, without action by a user. Such self-extracting files are often used by malware to enter and execute within a computer environment, and accordingly events associated with self-extracting sources are more likely to be malicious.

In some embodiments, the threat score for an event is increased from the baseline score when it is determined the computer process associated with the event originates from an archive file. In some embodiments, the threat score may be increased by a predetermined amount or by a predetermined percentage (e.g., 10%, 20%, 25% 30%, 40%, 50%, greater than 50%, 100%, greater than 100%, etc.). Archive files allow for different types of file system objects to be stored within a single file and may include metadata for executing computer programs associated with the file system objects. Archive files are often used for packaging software, which may be executed therefrom within a computer environment, and therefore are commonly used for packaging malware such as ransomware. Accordingly, computer processes originating from archive files are more likely to be malicious.

In some embodiments, the threat score for an event is decreased from a baseline score based on characteristics of the event indicative of not malicious events. In some embodiments, the threat score may be decreased by a predetermined amount or by a predetermined percentage (e.g., 10%, 20%, 25% 30%, 40%, 50%, greater than 50%, 100%, greater than 100%, etc.). In some embodiments, the threat score for an event is decreased when the event is associated with a known or recognized computer process, for example when the process associated with the event has a signature associated with a trusted process, when the process associated with the event is associated with a computer environment or device process, and/or when the process associated with the event is a whitelisted process. Such score decreases may reduce “false positives” when the security system classifies a benign event as malicious. In some embodiments, a user of a computer environment may identify sources such as programs, services or applications, which are considered to be trusted processes or whitelisted processes. In some embodiments, an event is considered not malicious when it is determined the event is associated with a known or recognized process.

In some embodiments, the threat score for an event is decreased from the baseline score when it is determined the process associated with the event is associated with operations of the computer environment, for example when the process associated with the event is running from a file associated with the computer environment, the operating system of the computer environment, or a device of the computer environment. Examples of such processes include service host processes (e.g., svchost.exe in a Windows environment), system software suite processes (e.g., systemd in a Lunix environment), processes or executables running from locations associated with the functioning of the operating system, computer environment, and/or devices of the computer environment (e.g., /sys, /system32, etc.), and/or processes or executables linked to operating system services (e.g., processes linked to Windows services and/or posix daemons). In some embodiments, the threat score may be decreased by a predetermined amount or by a predetermined percentage (e.g., 10%, 20%, 25% 30%, 40%, 50%, greater than 50%, 100%, greater than 100%, etc.). In some embodiments, an event is considered not malicious when it is determined the event is associated with operations of the computer environment.

In some embodiments, the threat score for an event is decreased from the baseline score when it is determined the computer process associated with the event is visible to a user of the computer environment. For example, a computer process may be visible to a user of the computer environment when there is a window associated with the process displayed to a user on a user interface of the computer environment. In some embodiments, the threat score may be decreased by a predetermined amount or by a predetermined percentage (e.g., 10%, 20%, 25% 30%, 40%, 50%, greater than 50%, 100%, greater than 100%, etc.). When a user can view and/or monitor a computer process, it is less likely to be a malicious process.

In some embodiments, when it is determined that an event is not a malicious event, the event is released such that the operating system of the computer environment may respond to the event. The operating system may, for example, return requested files or file metadata to a request from a computer process.

The inventors have recognized that threat scoring of events within a computer environment allows for recognition of events and/or computer processes which may be malicious and/or otherwise associated with a ransomware attack. In some cases, legitimate computer processes may perform actions and thus generate events similar to malicious processes and/or ransomware attacks. For example, a file backup process or cloud storage process within a computer environment may perform multiple access requests for file system objects within a short period of time. Such legitimate processes may lead to “false positives” where an information security system identifies the events associated with the process to be malicious. In some embodiments, an information security system may provide users of a computer environment with an option to manually override the malicious event classification and/or whitelist the computer process. This allows the information security system to minimize interruptions to the normal functioning of the computer environment. In some embodiments, the threat scoring may result in “false negatives” where the information security system identifies malicious events as not malicious. While such “false negatives” may expose the computer environment to a ransomware attack, the information security system is likely to identify malicious events correctly as the associated computer process will continue making requests to access file system objects and/or metadata, which will increase the threat score for the events associated with the process, thereby minimizing any risk from these “false negatives”.

In some embodiments, when it is determined that an event is a malicious event, the security system may generate a simulated response to the event such that the malicious event does not gain access to the file system objects of the computer environment or metadata of file system objects of the computer environment, thereby preventing encryption. In some embodiments, the simulated response may include simulated metadata generated based on the event and/or requested files or metadata. In some embodiments, the simulated metadata may be generated based on known behaviors of ransomware attacks, such that a ransomware attack associated with a malicious event is mitigated and cannot encrypt file system objects within a computer environment. In some embodiments, the simulated data may include simulated file system objects.

For example, in some embodiments, simulated metadata may indicate that one or more requested file system objects are folders, as opposed to content files such as document files, image files, or other types of files. Responsive to metadata indicating a file system object is a folder, a computer process of a ransomware attack may attempt to enumerate the file system objects within the folder to determine whether the file system objects within the folder should be encrypted. Whereas responsive to metadata indicating a file system object is a document file, image file, or similar file system object, a computer process of a ransomware attack may proceed to access and encrypt the file system object. Spoofing the metadata of a file system object as a folder will thus prevent encryption of the content of the file system object by a ransomware attack.

In some embodiments, simulated metadata may indicate that one or more requested file system objects are related to the functioning of the computer environment and/or devices of the computer environment. For example, in some embodiments, metadata for a file system object may be spoofed to indicate the file system object is a system file. Computer processes associated with ransomware attacks often will not interact with file system objects associated with computer environments or devices, as encryption or alteration of these file may cause the computer environment to stop functioning, therefore preventing the ransomware from further infecting the computer environment and/or from a ransom being paid in response to the attack. In some embodiments, in a Windows computer environment, simulated metadata may include file system attributes indicating the object is related to the system and/or device including: FILE_ATTRIBUTE_SYSTEM, FILE_ATTRIBUTE DEVICE. In some embodiments, in a Windows computer environment, the simulated metadata may include altered magic numbers of file headers, which indicate file types, to indicate file system objects are system and/or device related, for example by using: MZ in file headers, and/or PR in file headers. In some embodiments, in a Mac or Linux computer environment, attributes of metadata of a file system object may be extended to indicate the file system object is associated with the operating system of the computer environment, for example through “trusted.*” or “system.*” attributes. In some embodiments, in a Mac or Linux computer environment, simulated metadata may include altered inodes indicating a file system object is associated with a device nodes, for example through file modes “S_IFBLK” or “S_IFCHR”.

In some embodiments, simulated metadata may indicate that one or more requested file system objects cannot be accessed or altered, e.g., with read and/or write operations, by a computer process associated with a malicious event. Responsive to indications a file system object cannot be accessed, a computer program associated with a ransomware attack may determine not to access or encrypt the file system object and continue searching for other file system objects to access or encrypt. In some embodiments, in a Windows computer environment, simulated metadata may include file system attributes indicating a file system object is offline and thus not available to a malicious request, such as FILE_ATTRIBUTE_OFFLINE. In some embodiments, in a Windows computer environment, simulated metadata may include file system attributes indicating a file system object is hidden and thus not available to a malicious request, such as FILE_ATTRIBUTE_HIDDEN. In some embodiments, in a Mac or Linux computer environment, simulated metadata may include file permissions indicating that a computer process cannot read and/or write to a file system object, for example by including chmod 000 file permissions, or chmod 700 file permissions. In some embodiments, in a Mac or Linux computer environment, simulated metadata may indicate a file system object is a directory which a computer process cannot write to, for example through file mode “S_IFDIR”. In some embodiments, in a Mac or Linux computer environment, simulated metadata may indicate a file system object is hidden and therefore cannot be accessed by a computer process, for example by including a dot prefix (.), which indicates a file system object is hidden.

In some embodiments, a simulated latency may be applied before returning simulated metadata or requested metadata to a request associated with a malicious event. Such artificial delays may slow a ransomware attack, such as by slowing the time it takes to generate a list of files to encrypt and by making the encryption process slower and inefficient. These delays may cause ransomware attacks to skip over files that are slow when selecting files to encrypt or encrypting files, and/or may slow the progress of such attacks. Slowing ransomware attacks may provide more time for the information security system to detect the attack while simultaneously limiting the impact of the attack. In some embodiments, a constant delay may be introduced for each file system object requested for example, 10 ms, 50 ms, 100 ms, 200 ms, 500 ms, 10-500 ms, 10-1000 ms, or among other suitable delays. In some embodiments, the delays applied may vary based on the amount of file system objects requested. For example, the applied delay may increase for each file system object requested. In some embodiments, the delay may increase linearly for each file system object requested, for example, a first file system object may have a delay of 10 ms before being returned, a second file system object may have a delay of 20 ms, and a third file system object may have a delay of 30 ms. In some embodiments, the delay may increase exponentially for each file system object requested. In some embodiments, the delay may increase up to a maximum delay, which may be applied to all remaining requests. For example, a first file system object may have a delay of 10 ms applied, and each subsequent file system object may have a delay that is 10 ms longer than the previous object, up to 500 ms. In some embodiments, a random delay may be introduced for each file system object requested. For example, the delay may be randomly selected between 10-100 ms, 10-200 ms, 10-300 ms, 10-400 ms, 10-500 ms, 50-100 ms, 50-500 ms, 100-500 ms, 10-1000 ms, or other suitable ranges.

In some embodiments, simulated metadata may include an altered file path for the one or more requested file system objects. For example, simulated metadata including an altered file path for a file system object may be returned responsive to a malicious event including API function call to access data in a particular location in storage. The information security system may alter parameters of the API function to direct the call to a different, safe, location in storage, before allowing the operating system of the computer environment to respond to the call. The safe location in storage may include simulated file system objects which contain non-sensitive data and are safe to be encrypted by an attack. The operating system may then return simulated metadata from the different location in storage, the simulated metadata including data about the file system objects in the safe location in storage. Redirecting the file path of a malicious request allows a potential ransomware attack to proceed without encrypting important files system objects and thus increase the likelihood of detection.

In some embodiments, simulated metadata may direct a malicious event to one or more simulated file system objects. For example, simulated metadata may return a simulated file path to an event that leads to a location in storage with one or more simulated file system objects, for example to the different, safe locations in storage as discussed above. In some embodiments, the response to the event may additionally or alternatively include one or more simulated file system objects. The simulated file system objects may be simulated as the requested file system objects and may be designed to alter the behavior of a ransomware attack associated with the malicious event. For example, the simulated file system objects may be simulated as content files, therefore making them desirable for a ransomware to access and/or encrypt. Further, the simulated file system objects may be large in size and therefore would delay the progress of the ransomware attack when the attack attempts to access and/or encrypt the file system object. As an example, responsive to a request to enumerate the files within a folder, one or more simulated files may be returned, each simulated file being a PDF file with a large size (e.g., greater than 10 MB, greater than 50 MB, greater than 100 MB, greater than 250 MB, greater than 500 MB, etc.). Therefore, the ransomware attack will likely attempt to encrypt these files because they are content file, however, will be delayed when attempting to encrypt these files because of their size. Redirecting and delaying the ransomware attack will prevent it from accessing sensitive file system objects within a computer environment and will increase the likelihood of identifying the attack for remediation.

In some embodiments, simulated metadata may include modified checksums of requested file system objects. Checksums are used to verify the integrity of the data of an object, and simulated metadata may include modified checksums that indicate that data of an object has been corrupted. A ransomware attack may therefore choose not to attempt to access and/or encrypt corrupted file system objects because these the data of corrupted objects cannot be accessed.

In some embodiments, simulated metadata may indicate that storage associated with requested file system objects is disconnected from the computer environment in response to a malicious event. A ransomware attack may skip over these file system objects because the simulated metadata indicates they cannot be accessed for encryption.

Simulated metadata may be generated and returned responsive to an event determined to be a malicious event. In some embodiments, the above-described techniques for generating simulated metadata and/or for the content of simulated metadata may be used alone or in any combination of techniques. The inventors have recognized that by using multiple techniques in generating simulated metadata, malicious events are more likely to be redirected away from accessing sensitive data of file system objects within the computer environment.

In some embodiments, simulated metadata may be generated based on characteristics of requested file system object(s). In some embodiments, simulated metadata may be generated to indicate a requested file system object is a folder, is offline, and/or is corrupted, when a requested file system object is an object which may be accessed and/or altered by a user of the computer environment, e.g., content files including document files, presentation files, workbook files, image files, video files, and audio files, among similar file types. These files are likely to be encrypted by ransomware because they are files which are often accessed by computer environment users and it is therefore important to prevent malicious events from accessing these files or metadata of these files. Spoofing the characteristics of these file system objects through simulated metadata will prevent ransomware from encrypting these files because the ransomware will be led to believe that these files cannot be accessed.

In some embodiments, simulated metadata may be generated based on a location of requested file system object(s) in storage. For example, file system objects in a file path related to computer environment functionality, for example “/System32/usr/bin”, may be simulated as objects related to the functioning of the computer environment and/or devices of the computer environment. Such file system objects, regardless of their actual content, are more likely to be associated with the functioning of the computer environment or devices of the computer environment compared to file system objects in a file path associated with a user of the computer environment, for example “c:\users . . . ”, “/users/ . . . ”, or “/home . . . ”. Ransomware attacks may be less likely to attempt to access and/or encrypt file system objects in computer or device sensitive locations to avoid breaking the computer environment. It is important to ransomware attacks for computer environments to remain functional following the attack, so the attack is discovered and ransom is paid by a used of the environment. Simulated metadata indicating that file system objects in these locations are related to the functioning of the device or computer environment may cause the attack to skip over these objects, and therefore will prevent encryption of these objects.

In some embodiments, simulated metadata may be generated based on the metadata of the requested file system objects. For example, the creation date, last modified date, and owner of file system objects may be used in determining the technique for generating the simulated metadata for the file system objects. In some embodiments, file system objects which have been created and/or modified recently may have simulated metadata generated using multiple techniques and/or computationally expensive techniques to better protect this data. In some embodiments, file system objects which have not been created and/or modified recently may have simulated metadata generated using less computationally expensive techniques as these objects are less likely to be important to users of the computer environment. For example, a recently modified object may be simulated as having a corrupted checksum and a latency may be introduced before the simulated metadata is returned, whereas an object not recently modified may be simulated as having a corrupted checksum. In some embodiments, file system objects associated with prioritized users may have simulated metadata generated using multiple techniques or more computationally expensive techniques, as these file system objects are more important to protect. In some embodiments, file system objects not associated with prioritized users may have simulated metadata generated using less computationally expensive techniques, as these file system objects are less important to protect. In some embodiments, users of the computer environment may select prioritized users and/or file system objects to protect.

In some embodiments, simulated metadata may be generated based on the behavior of computer processes associated with a malicious event. In some embodiments, when a computer process associated with a malicious event is performing frequent and/or unusual read/write operations on a file system object, techniques for generating simulated metadata may be selected to protect the object. For example, simulated metadata may be generated to indicate the requested file system object is not available for the computer process to access, such as by showing the object as a folder, not available for read/write operations and/or as corrupted.

In some embodiments, when a computer process associated with a malicious event is making repeated attempts for accessing specific file system objects or file system object types, specific techniques for generating simulated metadata may be applied or additional techniques may be used. In some embodiments, when a computer process makes greater than a threshold number of requests or makes requests at a frequency greater than a threshold frequency, specific techniques for generating simulated metadata may be applied. For example, more computationally expensive techniques may be applied and/or additional techniques may be applied to protect the requested file system objects and/or type of file system objects.

The inventors have recognized that the techniques described herein for identifying malicious events and generating simulated metadata may improve the response of information security systems to ransomware attacks. The inventors have recognized that returning simulated metadata to malicious events while allowing the computer process associated with the event to continue improves the functioning of information security systems. The inventors recognized that some legitimate computer processes may generate events which are identified as malicious events based on their behavior, for example file backup processes or cloud storage processes. Therefore, terminating all processes associated with malicious events may disrupt the normal functioning of a computer environment. The techniques described herein allow computer processes which may be associated with ransomware to persist, while not providing these processes access to sensitive data or objects within the computer environment. Therefore, an information security system may deploy additional techniques for determining whether a computer process is associated with a ransomware attack, without the risk of the attack accessing and/or encrypting file system objects within the computer environment.

The inventors have additionally recognized that the techniques described herein for identifying malicious events and generating simulated metadata may improve responses to ransomware attacks because the attacks are addressed earlier stages in ransomware attacks than traditional techniques for identifying and remediating ransomware attacks. Traditional techniques for identifying and remediating ransomware attacks rely on known signatures of ransomware attacks that arise from file access and writing, which are generated later in a ransomware attack, once the attack has gained access to files of a computer environment. Therefore, these later interventions of traditional techniques for identifying and remediating ransomware attacks result in some file system objects of a computer environment being accessed and encrypted. The techniques described herein for identifying and remediating ransomware attacks prevent potentially malicious computer processes from accessing sensitive data within a computer environment and therefore prevent encryption from occurring, providing better protection from ransomware attacks.

In some embodiments, after simulated metadata is returned to a malicious request, the computer process associated with the request may be monitored to determine whether the processes is associated with a ransomware attack. In some embodiments, an information security system may analyze other events associated with the computer process to determine whether the process is associated with a ransomware attack. In some embodiments, a ransomware score may be determined for a computer process and when the ransomware score is greater than a threshold score, it is determined the process is associated with a ransomware attack. In some embodiments, when it is determined a computer process is associated with a ransomware attack, the information security system may perform one or more cybersecurity actions to address the ransomware attack. In some embodiments, the one or more cybersecurity actions may include: terminating the computer process, isolating the computer process such that it may not access file system objects of the computer environment, and/or analyzing actions performed by the computer process to determine the extent of the ransomware attack. Examples of techniques for identifying and addressing ransomware attacks are described in U.S. Pat. No. 10,789,361, entitled “RANSOMWARE ATTACK REMEDIATION”, which is incorporated by reference herein in its entirety.

While the techniques described herein are described with regard to mitigation of ransomware attacks, the inventors have recognized that the techniques may also protect computer environments against other types of malware which seek to gain access to and/or perform actions on file system objects of a computer environment. It should be appreciated that the techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

FIG. 1 A shows an example environment in which an information security system may operate, in accordance with some embodiments of the technology described herein. FIG. 1A includes computer environment 110 and ransomware attack(s) 130.

The components of computing environment 110 may be distributed in any suitable way. For example, in some embodiments, the components of computing environment 110 may be implemented as a single device. In some embodiments, the components of computing environment 110 may be implemented as multiple connected devices.

Computing environment 110 includes processor(s) 112, services 114, storage 116, applications 118 and information security system 120. Processors 112 may perform operations within the computing environment 110. Services 114 may include services associated with the operating system and functionality of the computer environment 110, for example, file management, memory management, and event logging, among other services. Applications 118 may include applications which users of computer environment 110 may interact with while using the computer environment, for example, word processing, web browsing, and image editing, among other applications. Storage 116 may store file system objects associated with the services 114, applications 118, information security system 120, and other objects necessary for the functioning of computer environment 110.

Information security system 120 may function to protect the computer environment 110 from various cybersecurity threats, for example ransomware attacks 130, spyware, and other types of malware. Information security system 120 is shown as internal to computing environment 110, however in some embodiments, one or more module(s) of information security system 120 may be deployed external to computing environment 110. The information security system 120 may function to identify and remediate cybersecurity threats.

FIG. 1B shows components of an example information security system within a computer environment, in accordance with some embodiments of the technology described herein. Information security system 120 may be configured to respond to ransomware attacks using the techniques described herein. As shown, the information security system 120 includes event capture module 122, threat scoring module 124, metadata simulation module 126, malware detection module 128, and malware remediation module 129.

The event capture module 122 may analyze events generated within computer environment 110 to determine whether events should be captured by the information security system 120, such that the operating system of the computer environment 110 is prevented from responding to them. In some embodiments, the event capture module may only capture specific events within the computer environment 110, for example events associated with requests to access file system objects and/or requests to access data related to file system objects stored in the computer environment 110. Examples of these events are described herein. The event capturing may be accomplished through hooking functions and/or filter drivers implemented in the computer environment 110, which may automatically isolate specific events for analysis by the information security system 120.

Threat scoring module 124 may function to determine whether events captured by the event capture module 122 are malicious events. The threat scoring module may determine a threat score for each captured event and when the threat score is greater than a threshold threat score, the event is determined to be a malicious event. When an event is determined not to be a malicious event, the event may be released by the information security system such that the operating system of the computer environment 110 may respond to the event.

The threat scoring module 124 may determine the threat score for each captured event based on characteristics of the captured event and optionally based on characteristics of the file system objects requested by the captured event. For example, as described herein, the threat score for a captured event may be determined based on a creation time of the computer process associated with the event, memory allocated to the computer process associated with the event, enumeration behavior of the computer process associated with the event, a signature of the computer process associated with the event, the file path of the computer process associated with the event, and/or a certificate of the computer process associated with the event, among other characteristics of the event. When it is determined that an event is a malicious event, the information security system may generate a response to the event.

Metadata simulation module 126 may be used to generate a response to malicious events. The metadata simulation module may analyze the malicious event and/or the data requested by the event to determine simulated metadata to return responsive to the event. The simulated metadata may be selected to prevent the malicious event from accessing the data related to the requested file system objects. The simulated metadata may include metadata indicating requested files system object(s) are folder(s), related to the functioning of the computer environment 110, related to functioning of devices within computer environment 110, not available for the computer process associated with the malicious event to perform read/write operations to, in a different file path from the true file path, corrupted, and/or have an increased latency to access, among other indications as described herein. The simulated metadata may be returned responsive to the malicious event, to prevent the computer process associated with the malicious event from accessing data related to the requested file system object(s).

The information security system 120 additionally includes malware detection module 128 and malware remediation module 129. Malware detection module 128 may function to determine whether the information security system 120 is undergoing a cybersecurity attack, for example by analyzing computer processes associated with malicious events, as described herein. Malware remediation module 129 may function to address cyber security attacks after they are identified, for example by terminating computer processes associated with cybersecurity attacks, isolating computer processes associated with cybersecurity attacks, and/or determining the impact of a cybersecurity attack on the computer environment 110.

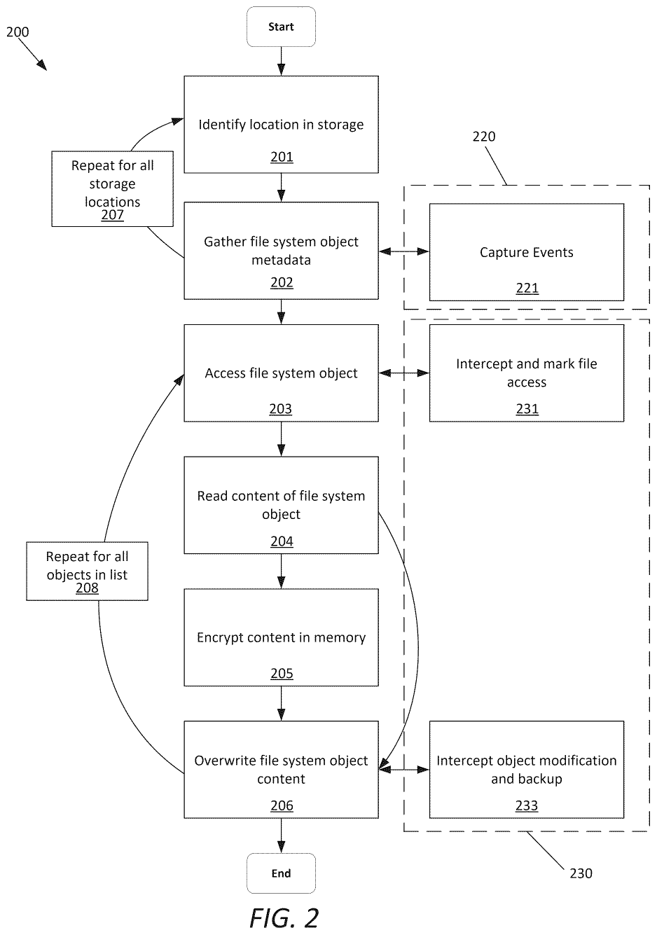

The information security system 120 may be configured to address ransomware attacks, such as ransomware attacks 130, and prevent these attacks from accessing and/or encrypting files within storage 116. Ransomware attacks 130 may be introduced into computer environment 110 through various sources, such as Internet downloaded files, files sent thorough internet communications, and/or files introduced through physically connected storage, among other sources. Ransomware attacks 130 may proceed within computer environment 110 as shown in FIG. 2.

FIG. 2 is an example of a process which may be performed by a ransomware attack. The process 200 shown in FIG. 2 includes acts 201-208 is a generic process which is generally applicable to most ransomware attacks, however specific ransomware attacks may include different steps based on their complexity and/or the computer environment to which they are deployed. FIG. 2 also shows acts 220 and 230 that may be performed by an information security system (e.g., information security system 120 of FIGS. 1A-B) to thwart ransomware attacks.

Process 200 begins at step 201, in which the ransomware identifies a location in storage of a computer environment. This may be for example, a file path, a folder, and/or a partition within the file storage of a computer environment, such as storage 116 of FIG. 1A-B. Within the location in storage, the ransomware then gathers the file system object metadata of the file system objects stored at that location in step 202. The ransomware may determine based on the metadata whether the file system object should be added to a list of file system objects to encrypt or whether the file system object should not be encrypted.

The ransomware may repeat steps 201 and 202 for all locations in storage to generate a complete list of file system objects stored in the file storage of the computer environment to encrypt, as shown by loop 207. In some cases, the ransomware may proceed to step 203 after gathering metadata for all file system objects in a particular location in storage.

After determining the list of file system objects to encrypt, the ransomware then begins the process of encrypting the objects. At step 203, the ransomware will access a system object. The ransomware will then read the contents of the file system object at step 204. The contents of the file system object are then encrypted in memory in step 205. Finally, the content of the file system object is overwritten, such that when a user of the computer system tries to access the file system object, the previous content of the object is not available. Steps 203-206 may then be repeated by the ransomware process for all objects in the list of file system objects to encrypt, as shown by loop 208. Alternatively, some ransomware attacks may instead create encrypted copies of file system objects and delete the original content.

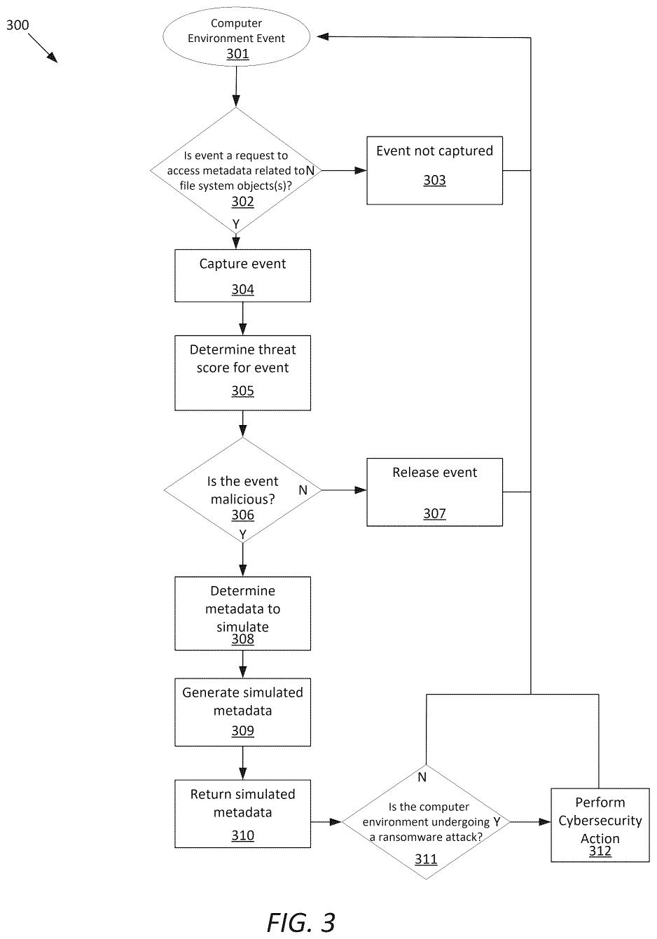

An information security system, such as system 120 of FIGS. 1A-B, may perform security actions to identify and/or address ransomware attacks. An example of such security actions which may be performed by an information security system according to the techniques described herein, is shown in FIG. 2, as acts 220 and 230. As described herein, the inventors have developed techniques for mitigating ransomware attacks which are performed at early stages of the attack. Act 220 is an example of ransomware mitigation occurring at an early stage of the attack and includes action 221, which involves capturing events. Captured events may be analyzed to determine whether actions should be taken to mitigate a ransomware attack. These techniques for early stage mitigation of ransomware attacks are described herein including next with respect to FIG. 3.

Information security systems, such as information security system 120 of FIGS. 1A-B, may additionally perform security actions to identify and/or address ransomware attacks during later stages of the attack. Acts 230 is an example of ransomware mitigation occurring at later stages if an attack and include actions 231 and 233. Action 231 involves intercepting file access requests and marking these requests as the ransomware is accessing file system objects. Action 233 involves intercepting data related to object modifications and backups as the ransomware is overwriting file system object content. As described herein, such mitigation actions are performed only after the ransomware attacks have accessed and/or encrypted files, and therefore leave the computer environment exposed to ransomware attacks when used in isolation. However, the inventors have recognized that combining these techniques with the techniques for early detection and mitigation of attacks described herein may be used in combination, in accordance with some embodiments, as they complement one another and provide a layered defensive approach to security.

The techniques for detecting and mitigating ransomware attacks developed by the inventors detect malicious events associated with ransomware attacks during early stages of the attack and thus prevent the attack from progressing to stages where it accesses or encrypts file system objects. The inventors have recognized that this early detection of ransomware attacks and preventing the attacks from accessing and/or encrypting file system objects provides an improvement over techniques which do not prevent attacks from progressing to accessing and encrypting objects. By spoofing metadata of file system objects, the techniques described herein prevent ransomware attacks from adding objects to a list to encrypt and from encrypting these objects. In some embodiments, information security systems described herein may be configured to perform such early detection of ransomware attacks and may additionally be configured to detect ransomware attacks at later stages such as during access and/or encryption.

FIG. 3 is an example process which may be performed by an information security system to prevent ransomware attacks from accessing file system objects, in accordance with some embodiments of the technology described herein. Process 300 may be performed by an information security system such as system 120 of FIGS. 1A-B.

Process 300 begins when the information security system receives an event 301 from the computer environment for review. The event 301 may be read from an event log of the computer environment. The information security system determines at act 302 whether the event 301 is a request to access metadata related to file system objects(s) of the computer environment. Act 302 may be performed by an event capture module of an information security system, such as event capture module 122 of FIG. 1B. When the event 301 is not a request to access metadata of file system objects, the event is not captured and the operating system of the computer environment may respond to the event, as shown by block 303. The process 300 may then proceed to analyze another event from the computer environment, for example a next event in an event log of the computer environment.

When it is determined the event 301 is a request to access metadata related to file system objects of the computer environment at act 302, the event proceeds to act 304, where the event is captured. Act 304 may be performed by an event capture module of an information security system, such as event capture module 122 of FIG. 1B. When the event is captured, the operating system of the computer environment is prevented from responding to the event.

The process 300 then proceeds to act 305 where a threat score for the event is determined. Act 305 may be performed by a threat scoring module of an information security system, such as threat scoring module 324 of FIG. 1B. The threat score may be determined based on characteristics of the event and optionally on characteristics of the requested file system objects, as described herein. For example, the threat score may be determined based on a creation time of the computer process associated with the event, memory allocated to the computer process associated with the event, enumeration behavior of the computer process associated with the event, a signature of the computer process associated with the event, the file path of the computer process associated with the event, and/or a certificate of the computer process associated with the event, among other characteristics of the event as described herein. In some embodiments, the event 301 may be assigned a baseline threat score, which is adjusted up or down based on characteristics of the event. Specific examples of event characteristics and their impact on a threat score are provided herein.

Process 300 then proceeds to act 306, which may be performed by a threat scoring module of an information security system, such as threat scoring module 124 of FIG. 1B. At act 306, it is determined whether the event is a malicious event. The event may be determined to be a malicious event when the threat score for the event exceeds a threshold threat score. The threshold threat score may be set to avoid “false positives” when events associated with legitimate computer processes are identified as malicious, as described herein. When it is determined that an event is not malicious, the event is released at act 307, such that the operating system of the computer environment may respond to the event. The information security system may then proceed to analyze another event.

When it is determined the event is a malicious event at act 306, the process 300 proceeds to act 308. Act 308 may be performed by a metadata simulation module of an information security system, for example metadata simulation module 126 of FIG. 1B. At act 308, the metadata to simulate is determined. As described herein, the metadata to simulate may be determined based on characteristics of the event and/or the requested file system objects. For example, the metadata to simulate may be determined based on a location of the requested file system objects within the storage of the computer environment, metadata of the requested file system objects, and/or behavior of the computer process associated with the event 301, as described herein.

The simulated metadata is generated at act 309. The simulated metadata may include metadata indicating requested files system object(s) are folder(s) are: (1) related to the functioning of the computer environment; (2) related to functioning of devices within computer environment; (3) not available for the computer process associated with the malicious event to perform read/write operations to, (4) are in a different file path from the true file path, are corrupted, and/or (5) have an increased latency to access, among other indications as described herein.

At act 310, the simulated metadata is returned responsive to the event. The simulated metadata will prevent the computer process associated with the event from accessing the actual data of the requested file system objects, and therefore, will prevent ransomware from accessing and/or encrypting the data of the requested file system objects. The simulated metadata will additionally prevent ransomware from becoming aware of the existence of the requested file system objects within the computer environment and therefore will prevent these objects from being added to a list of objects to encrypt by the ransomware attack.

In some embodiments, after the simulated metadata is returned at act 310, the process may proceed to analyze another event from the computer environment. In some embodiments, the process may proceed to act 311 where it is determined whether the computer environment is undergoing a ransomware attack. Act 311 may be performed by a malware detection module, for example module 128 of FIG. 1B. The information security system may determine whether the computer system is undergoing a ransomware attack by analyzing other events related to the computer process associated with the malicious event, and/or other characteristics of the malicious event or associated computer process, as described herein. When it is determined the computer system is not undergoing a ransomware attack, the information security system may proceed to analyze another event from the computer environment.

When it is determined the computer system is undergoing a ransomware attack, the process may proceed to act 312, where the information security system performs one or more cybersecurity actions to address the ransomware attack. These cybersecurity actions may include isolating a computer process associated with the ransomware attack, terminating the computer process associated with the ransomware attack and/or analyzing the actions performed by the computer process associated with the ransomware attack to determine the extent of the attack, as described herein. Act 312 may be performed by a malware remediation module of an information security system such as module 129 of FIG. 1B.

After performing act 312, the process may restart by analyzing another event within the computer environment. The process 300 may be continually run by an information security system to monitor events within a computer environment for malicious events which may be associated with ransomware attacks. This process allows for information security systems to identify potential ransomware attacks at early stages of the attacks and prevent the computer processes associated with the attacks from accessing/encrypting data associated with file system objects stored in the computer environment and from adding file system objects to a list of objects to encrypt, as described herein.

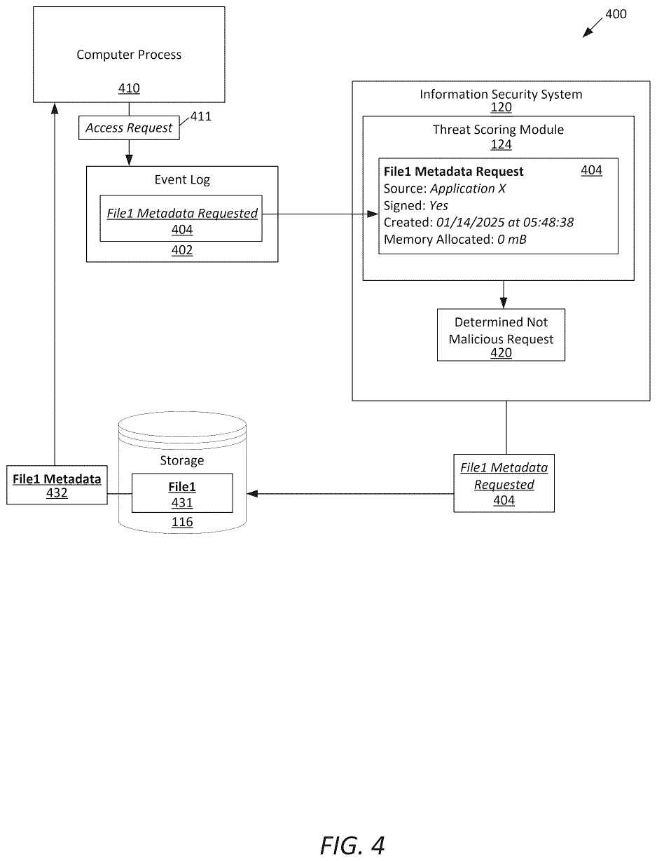

FIG. 4 is an example data flow which may be performed within a computer environment responsive to a non-malicious event, in accordance with some embodiments of the technology described herein. The data flow shown in FIG. 4 may be performed within computer environment 110 as described with reference to FIGS. 1A-B.

As shown computer process 410 makes an access request for metadata related to File1 431 within storage 116. This request is posted to event log 402 as event 404. An event capture module such as module 122 of FIG. 1B may identify event 404 as a request for metadata related to a file system object within the computer environment. Therefore, event 404 is captured by information security system 120 for analysis.

Event 404 is analyzed by threat scoring module 124. As shown, event 404 includes data related to the computer process 410, for example, the source of the process is Application X, the event is signed, the event was created on Jan. 14, 2025 at 05:48:38 and there is no memory allocated for the computer process 410. In some embodiments, data about events may include greater or fewer characteristics of the event. These characteristics of event 404 are not likely to be associated with a malicious event, and the known source, signature of the event, not recent creation time and lack of memory allocation may decrease the threat score for the event from a baseline score, as described herein. Therefore, the threat score for the event 404 is below the threshold threat score and the event is determined to not be malicious, as shown by block 420.

After the event 404 is determined to not be malicious, the event 404 is released by the information security system, such that the operating system of the computer environment may respond to the event. As shown, Filel metadata 432 is retrieved from storage 116 and provided to computer process 410 in response to event 404.

It is important for information security systems, such as system 120, to recognize when events having some characteristics of malicious events are not malicious. Some legitimate computer processes may have behaviors similar to ransomware. For example, computer processes associated with backing up stored file system objects may request and access metadata of stored file system objects, similar to a ransomware attack. Determining a threat score for the events allows the information security system 120 to determine which events are malicious and require action and which events are not malicious. This minimizes the impact of the information security system 120 on the normal functioning of the computer system, as these legitimate processes may continue to run uninterrupted, while malicious processes may be addressed. In events of “false positives,” where legitimate events are determined to be malicious, a user of the computer system may manually override the information security system. In events of “false negatives,” where malicious events are determined to not be malicious, future events from the computer process associated with the malicious event may be identified as malicious due to the behavior of the computer process, as described herein.

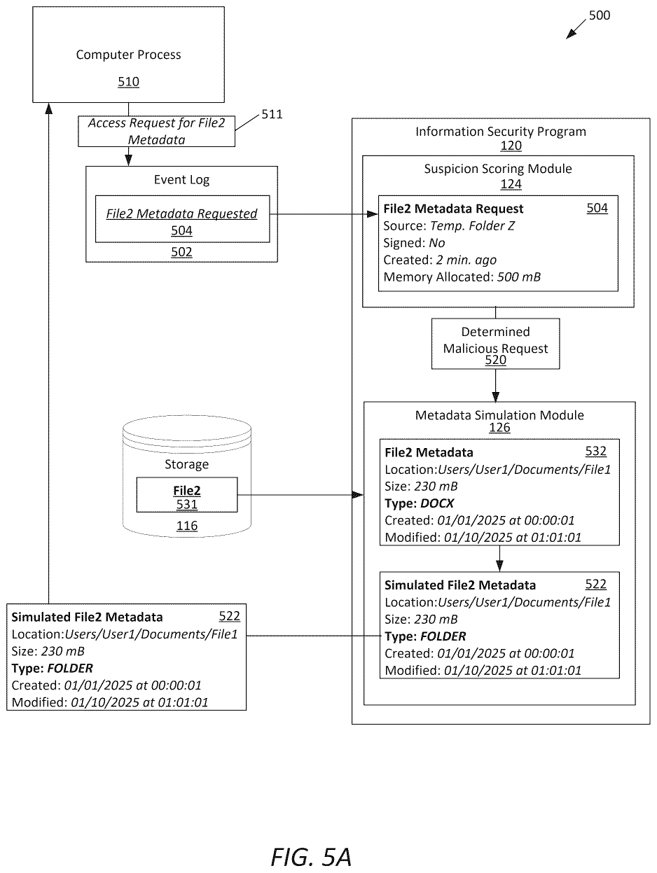

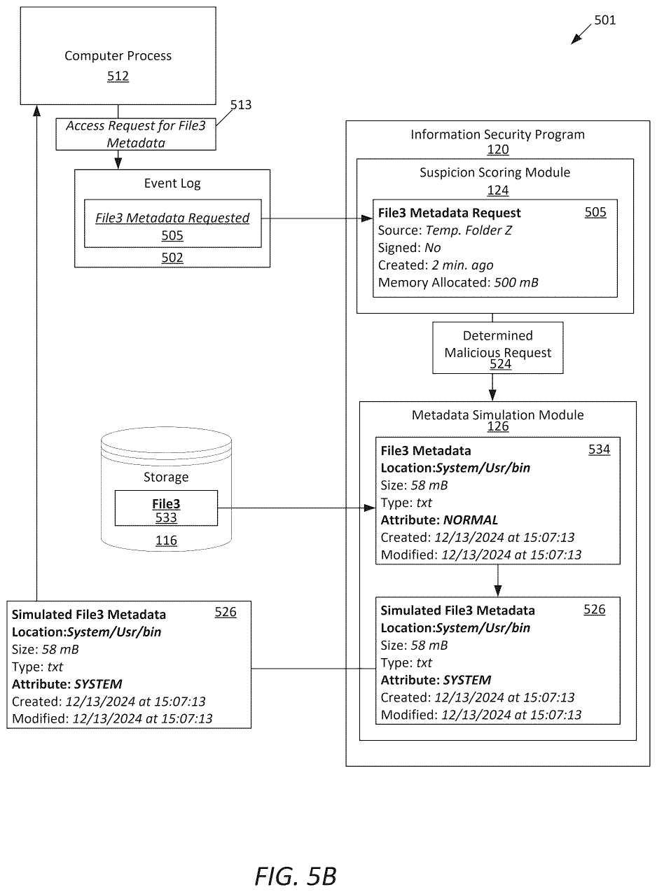

FIGS. 5A-B are example data flows which may be performed within a computer environment responsive to a malicious events, in accordance with some embodiments of the technology described herein. The data flow shown in FIGS. 5A-B may be performed within computer environment 110 as described with reference to FIGS. 1A-B.

As shown in FIG. 5A, computer process 510 makes an access request for metadata related to File2 531 within storage 116. This request is posted to event log 502 as event 504. An event capture module such as module 122 of FIG. 1B may identify event 504 as a request for metadata related to a file system object within the computer environment. Therefore, event 504 is captured by information security system 120 for analysis.

Event 504 is analyzed by threat scoring module 124. As shown, event 504 includes data related to the computer process 510, for example, the source of the process is Temp. Folder Z, the event is not signed, the event was created 2 minutes ago and there is 500 mB of memory allocated for the computer process 510. In some embodiments, data about events may include greater or fewer characteristics of the event. These characteristics of event 504 are likely to be associated with a malicious event, and the temporary folder in the file path of the process 510, the lack of a signature of the event, the recent creation time and memory allocation may all increase the threat score for the event from a baseline score, as described herein. Therefore, the threat score for the event 504 is above the threshold threat score and the event is determined to be malicious, as shown by block 520.

After the event 504 is determined to be malicious, the information security system 120 proceeds to simulate metadata to provide in response to the event. As described herein, simulated metadata will prevent a malicious computer process from accessing file system objects and data related to file system objects within a computer environment. Therefore, a ransomware attack will be prevented from forming a list of file system objects to encrypt and from accessing and/or encrypting file system objects within a computer environment.

The metadata simulation module 126 must determine what metadata should be simulated responsive to the malicious event. In some embodiments, simulated metadata may be generated “from scratch,” and not based on the requested file system object(s). In some embodiments, such as shown in FIG. 5A, the simulated metadata is generated based on the metadata of the requested File2. File2 metadata 532 may be requested by the metadata simulation module 126, and obtained from storage 116 where File2 531 is stored. As shown, the File2 metadata includes information related to File2, including its location in storage, size, a created time, and a last modified time. In some embodiments, metadata related to file system objects may include greater or fewer characteristics of the file system object.

To determine the metadata to simulate for File2, the metadata simulation module may analyze the file type for File2 from File2 metadata 532. As shown, File2 is a DOCX file, indicating it is a file that a user of the computer environment may interact with regularly and may include content valuable to the user. The location of File2 may also be analyzed, which indicates that File2 is in a location in storage associated with user files of the computer environment.

After analyzing the File2 metadata 532, the metadata simulation module may generate simulated File2 metadata 522. As shown simulated File2 metadata is based on File2 metadata 532, however the file type is changed from DOCX to FOLDER. This change is based on the file type of File2 and/or the location in storage of File2, as it is common for FOLDER type objects to be stored alongside DOCX files within a computer environment. The simulated File2 metadata 522 is then returned to the computer process 510.

Changing the file type to FOLDER will prevent ransomware attacks from accessing and/or encrypting data related to File2, and will prevent ransomware from adding File2 to a list of objects to encrypt. Ransomware attacks will commonly seek to encrypt individual file system objects within a computer environment, as these are objects are typically more important to a user of the computer environment. A ransomware attack will commonly seek to enumerate the file system objects within a folder, to determine whether these objects should be encrypted, as opposed to encrypting the folder itself. Therefore, by changing the file type of File2 to FOLDER in simulated File2 metadata 522, a potential ransomware attack associated with computer process 510 may attempt to enumerate the file system objects within File2, as opposed to adding File2 to a list of objects to encrypt. The computer system may respond to a request to enumerate the objects within File2 with “null” as File2 does not store any file system objects. Therefore, the simulated File2metadata 522 may cause a ransomware attack to treat File2 as an empty folder as opposed to a DOCX file.

As shown in FIG. 5B, computer process 512 makes an access request for metadata related to File3 533 within storage 116. This request is posted to event log 502 as event 505. An event capture module such as module 122 of FIG. 1B may identify event 505 as a request for metadata related to a file system object within the computer environment. Therefore, event 505 is captured by information security system 120 for analysis.

Event 505 is analyzed by threat scoring module 124. As shown, event 505 includes the same characteristics as event 504 of FIG. 5A and is therefore determined to be a malicious event.

After the event 505 is determined to be malicious, the information security system 120 proceeds to simulate metadata to provide in response to the event. The metadata simulation module 126 must determine what metadata should be simulated responsive to the malicious event. The simulated metadata may be generated based on the metadata of File3. File3 metadata 534 may be requested by the metadata simulation module 126, and obtained from storage 116 where File3 533 is stored. As shown, the File3 metadata includes information related to File3, including its location in storage, size, attribute, a created time, and a last modified time. In some embodiments, metadata related to file system objects may include greater or fewer characteristics of the file system object.

To determine the metadata to simulate for File3, the metadata simulation module may analyze the file location and attribute from File3 metadata 534. As shown, File3 is located in storage associated with the system files of the computer environment. File system objects stored in storage locations associated with the system of the computer environment are typically critical for the operation of the computer environment and/or devices of the computer environment. Therefore, any changes to these files may prevent the computer environment from functioning properly. However, some non-system critical files may be stored in this location and may have attributes indicating they are not associated with the functioning of the computer environment and/or devices, such as the NORMAL attribute of File3 metadata 534. The metadata simulation module may seek to indicate that File3 is a system-critical file, which will likely prevent a ransomware attack from accessing and/or encrypting the file and from adding the file to a list of files to encrypt.

After analyzing the File3 metadata 534, the metadata simulation module may generate simulated File3 metadata 526. As shown simulated File3 metadata is based on File3 metadata 534, however the file attribute is changed from NORMAL to SYSTEM. This change is based on the file attribute and location for File3. The simulated File2 metadata 522 is then returned to the computer process 510.

Changing the file attribute to SYSTEM will prevent ransomware attacks from accessing and/or encrypting data related to File3, and will prevent ransomware from adding File3 to a list of objects to encrypt. Ransomware attacks will commonly avoid accessing and changing system-critical files of a computer environment, as these files are necessary for the functioning of the computer environment. If system-critical files of a computer environment are altered, the computer environment may stop functioning, which would prevent the ransomware attack from spreading further within the computer environment and would prevent a user of the computer environment from using the environment and thus discovering the ransomware attack bas occurred. Therefore, by changing the attribute of File3 to SYSTEM in simulated File3 metadata 526, a potential ransomware attack associated with computer process 512 may skip over File3, as opposed to adding File3 to a list of objects to encrypt or accessing and/or encrypting the file.

FIGS. 5A-B are examples of responses an information security system to a malicious event. In some embodiments, information security systems may determine events are malicious based on greater or fewer characteristics of the events, as described herein. In some embodiments, information security systems may determine the metadata to simulate based on greater or fewer characteristics of a requested file system object, as described herein. In some embodiments, information security systems may determine the metadata to simulate based additionally or alternatively on characteristics of the malicious event, as described herein. In some embodiments, the simulated metadata may include additional or different changes from the metadata of the requested objects, as described herein.

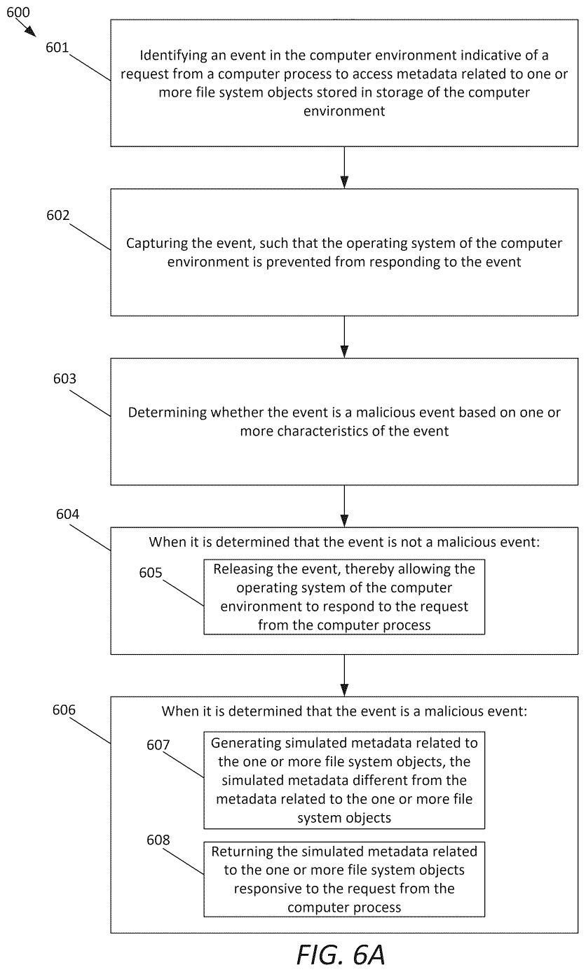

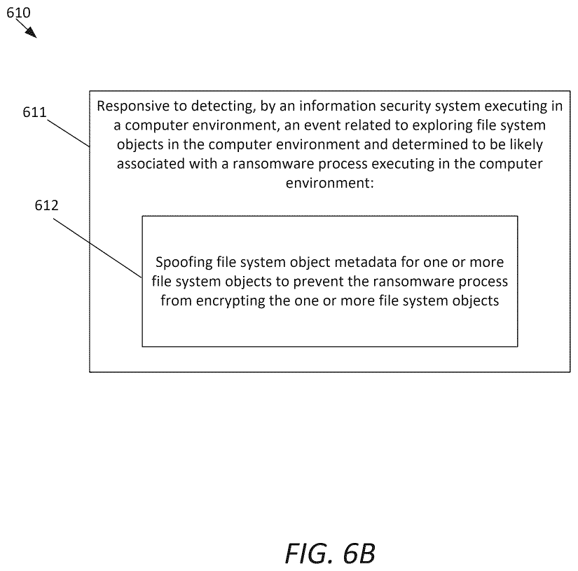

FIG. 6A is an example process for identifying malicious events and generating simulated metadata to return responsive to malicious events, in accordance with some embodiments of the technology described herein. The process 600 may be performed by an information security system of a computer environment, for example information security system 120 as described with respect to FIGS. 1A-B.

Process 600 begins with act 601, in which the information security system identifies an event in the computer environment indicative of a request from a computer process to access metadata related to one or more file system objects stored in storage of the computer environment. Act 601 may be performed by an event capture module such as module 122 of FIG. 1B. Events may be shown in an event log of a computer environment where they may be analyzed. Events indicative of requests to access metadata related to file system objects are indicative of potential ransomware attacks, as these attacks will access this data when determining which file system objects of a computer environment to encrypt. Examples of such events are provided herein. This is an early stage of ransomware attacks and therefore addressing events which may be associated with potential attacks helps to limit the impact of the attacks.

Process 600 then proceeds to act 602, in which the information security system captures the event, such that the operating system of the computer environment is prevented from responding to the event. Act 602 may be performed by an event capture module such as module 122 of FIG. 1B. Events may be captured through hooking functions implemented within the computer environment, as described herein. It is important to prevent the operating system from responding to these events before it is determined whether the events are malicious or not, as the events may be associated with a ransomware attack. Preventing a potential ransomware attack from accessing metadata of file system objects within a computer environment will prevent it from accessing and/or encrypting these objects and adding the objects to a list of objects to encrypt, as described herein.

Process 600 then proceeds to act 603, in which the information security system determines whether the event is a malicious event based on one or more characteristics of the event. Act 603 may be performed by a threat scoring module of an information security system, for example module 124 of FIG. 1B. Various characteristics of the event may be analyzed to determine whether the event is malicious or not. For example, a creation time of the computer process associated with the event, memory allocated to the computer process associated with the event, enumeration behavior of the computer process associated with the event, a signature of the computer process associated with the event, the file path of the computer process associated with the event, and/or a certificate of the computer process associated with the event, among other characteristics of the event may be analyzed as described herein. In some embodiments, a threat score may be determined for the event, and the event is determined to be malicious when the threat score exceeds a threshold threat score. In some embodiments, the event is assigned a baseline threat score, which is adjusted up or down based on the characteristics of the event.

When it is determined that the event is not a malicious event, the process 600 proceeds to act 604, which includes sub-step 605. At sub-step 605, the information security system releases the event, thereby allowing the operating system of the computer environment to respond to the request from the computer process.

When it is determined that the event is a malicious event, the process 600 proceeds to act 606, which includes sub-steps 607 and 608. Act 606 may be performed by a metadata simulation module of an information security system, for example module 126 of FIG. 1B. At sub-step 607, the information security system generates simulated metadata related to the one or more file system objects, the simulated metadata different from the metadata related to the one or more file system objects. The simulated metadata may be generated based on characteristics of the requested file system object and/or the malicious event, as described herein. In some embodiments, the simulated metadata to generate is determined based on a location of the requested file system objects within the storage of the computer environment, metadata of the requested file system objects, and/or behavior of the computer process associated with the event, as described herein. Specific examples of simulated metadata and characteristics used to generate simulated metadata are provided herein.

The process 600 then proceeds to sub-step 608, in which the information security system returns the simulated metadata related to the one or more file system objects responsive to the request from the computer process. As described herein, if the computer process is a ransomware attack, the simulated metadata may cause the attack not to add the requested file system objects to a list of objects to encrypt, and/or not access and/or encrypt the requested file system objects. This will prevent the ransomware attack from progressing and may delay the attack such that the attack may be identified and confirmed by the information security system. In some embodiments, the information security system may analyze other events related to the computer process to determine whether they are associated with a ransomware attack and perform cyber security actions to address the ransomware attack, as described herein.

FIG. 6B is an example process for mitigating a ransomware attack, in accordance with some embodiments of the technology described herein. The process 610 may be performed by an information security system of a computer environment, for example information security system 120 as described with respect to FIGS. 1A-B.

Process 610 begins with act 611. Act 611 is performed responsive to detecting, by an information security system executing in a computer environment, an event related to exploring file system objects in the computer environment and determined to be likely associated with a ransomware process executing in the computer environment, and includes sub-step 612. Events related to exploring file system objects in the computer environment may include requests to access one or more file system objects and/or file system object metadata, as described herein. Events determined to be likely associated with a ransomware process executing in the computer environment may be determined based on characteristics about the event, such as the computer process associated with the event and/or the related file system objects, as described herein.

Sub-step 612 involves spoofing file system object metadata for one or more file system objects to prevent the ransomware process from encrypting the one or more file system objects. Spoofing file system object metadata may include generating simulated metadata, as described herein. The spoofed metadata may may be generated based on characteristics of the requested file system object and/or the malicious event, as described herein. In some embodiments, the spoofed metadata is generated based on a location of requested file system objects within the storage of the computer environment, metadata of requested file system objects, and/or behavior of the computer process associated with the event, as described herein. Specific examples of spoofing metadata and characteristics used to generate spoofed metadata are provided herein.

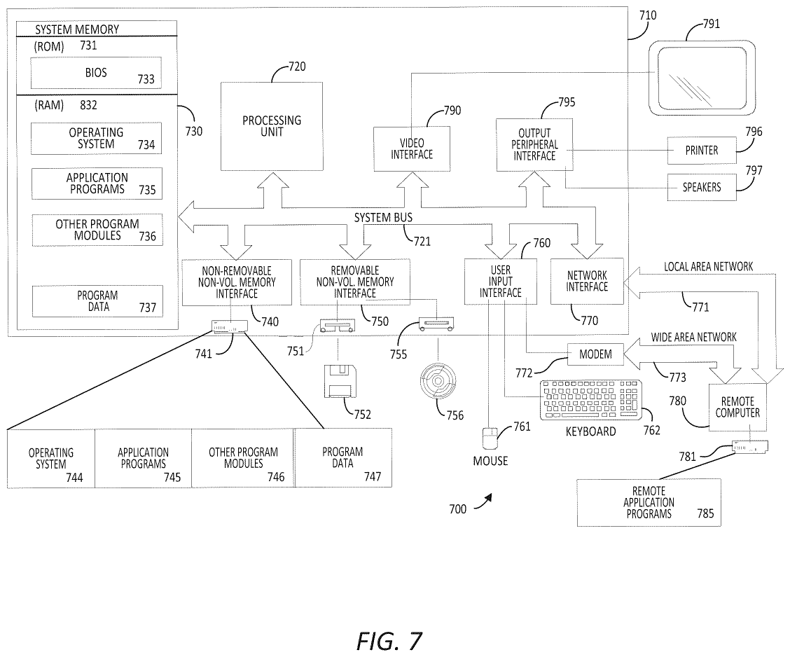

FIG. 7 shows a block diagram of an exemplary computing device, in accordance with some embodiments of the technology described herein. The computing system environment 700 is only one example of a suitable computing environment and is not intended to suggest any limitation as to the scope of use or functionality of the technology described herein.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 7, an exemplary system for implementing the technology described herein includes a general-purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 730 includes computer storage media in the form of volatile and/or nonvolatile memory such as read only memory (ROM) 431 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile or nonvolatile computer storage media. By way of example only, FIG. 7 illustrates a hard disk drive 741 that reads from or writes to non-removable, nonvolatile magnetic media, a flash drive 751 that reads from or writes to a removable, nonvolatile memory 752 such as flash memory, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media described above and illustrated in FIG. 7, provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. An actor may enter commands and information into the computer 710 through input devices such as a keyboard 762 and pointing device 761, commonly referred to as a mouse, trackball, or touch pad. Other input devices (not shown) may include a microphone, joystick, game pad, satellite dish, scanner, or the like. These and other input devices are often connected to the processing unit 720 through a user input interface 760 that is coupled to the system bus but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a server, a router, a network PC, a peer device, or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773 but may also include other networks. Such networking environments are commonplace in offices, enterprise-wide computer networks, intranets, and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the actor input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

Having thus described several aspects of at least one embodiment of the technology described herein, it is to be appreciated that various alterations, modifications, and improvements will readily occur to those skilled in the art. Such alterations, modifications, and improvements are intended to be part of this disclosure and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, a tablet computer, a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. A computer-readable storage medium includes any computer memory configured to store software, for example, the memory of any computing device such as a smart phone, a laptop, a desktop, a rack-mounted computer, or a server (e.g., a server storing software distributed by downloading over a network, such as an app store)). As used herein, the term “computer-readable storage medium” encompasses only a non-transitory computer-readable medium that can be considered to be a manufacture (i.e., article of manufacture) or a machine. Alternatively, or additionally, aspects of the technology described herein may be embodied as a computer readable medium other than a computer-readable storage medium, such as a propagating signal.

The terms “program” or “software” are used herein in a generic sense to refer to any type of computer code or set of processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor but may be distributed in a modular fashion among a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 3-6B. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1-20. (canceled)

21. A method for mitigating ransomware attacks in a computer environment, the method comprising:
using a computer hardware processor to perform:
responsive to detecting, by an information security system executing in the computer environment, an event related to exploring file system objects in the computer environment and determined to be likely associated with a ransomware process executing in the computer environment:
spoofing file system object metadata for one or more file system objects to prevent the ransomware process from encrypting the one or more file system objects.

22. The method of claim 21, wherein:
the one or more file system objects include a first content file; and
spoofing the metadata for the one or more file system objects comprises spoofing the metadata for the first content file by generating metadata that indicates the content file to be a folder rather than a content file.

23. The method of claim 21, wherein:
the one or more file system objects include a first file system object; and
spoofing the metadata for the one or more file system objects comprises spoofing the metadata for the first file system object by generating metadata for the first file system object that indicates the first file system object is offline.

24. The method of claim 21, wherein:
the one or more file system objects include a first file system object stored in a system related file path; and
spoofing the metadata for the one or more file system objects comprises spoofing the metadata for the first file system object by generating metadata for the first file system object that indicates the first file system object is a system file.

25. The method of claim 21, wherein:
the one or more file system objects include a first content file; and
spoofing the metadata for the one or more file system objects comprises spoofing the metadata for the first content file by generating metadata for the first content file including a checksum indicating the first content file is corrupted.

26. The method of claim 21, further comprising:
returning the spoofed metadata responsive to the event with a predetermined latency.

27. The method of claim 21, further comprising:
responsive to the detecting:
capturing the event such that an operating system of the computer environment is prevented from responding to the event.

28. A system for mitigating ransomware attacks in a computer environment, the system comprising:
at least one computer hardware processor; and
at least one non-transitory computer-readable storage medium storing processor-executable instructions that, when executed by the at least one computer hardware processor, causes the at least one computer hardware processor to perform a method comprising:
responsive to detecting, by an information security system executing in the computer environment, an event related to exploring file system objects in the computer environment and determined to be likely associated with a ransomware process executing in the computer environment:
spoofing file system object metadata for one or more file system objects to prevent the ransomware process from encrypting the one or more file system objects.

29. The system of claim 28, wherein:
the one or more file system objects include a first content file; and
spoofing the metadata for the one or more file system objects comprises spoofing the metadata for the first content file by generating metadata that indicates the content file to be a folder rather than a content file.

30. The system of claim 28, wherein:
the one or more file system objects include a first file system object; and
spoofing the metadata for the one or more file system objects comprises spoofing the metadata for the first file system object by generating metadata for the first file system object that indicates the first file system object is offline.

31. The system of claim 28, wherein:
the one or more file system objects include a first file system object stored in a system related file path; and
spoofing the metadata for the one or more file system objects comprises spoofing the metadata for the first file system object by generating metadata for the first file system object that indicates the first file system object is a system file.

32. The system of claim 28, wherein:
the one or more file system objects include a first content file; and
spoofing the metadata for the one or more file system objects comprises spoofing the metadata for the first content file by generating metadata for the first content file including a checksum indicating the first content file is corrupted.

33. The system of claim 28, wherein the least one non-transitory computer-readable storage medium stores further processor-executable instructions that, when executed by the at least one computer hardware processor, causes the at least one computer hardware processor to perform:
returning the spoofed metadata responsive to the event with a predetermined latency.

34. The system of claim 28, wherein the least one non-transitory computer-readable storage medium stores further processor-executable instructions that, when executed by the at least one computer hardware processor, causes the at least one computer hardware processor to perform:
responsive to the detecting:
capturing the event such that an operating system of the computer environment is prevented from responding to the event.

35. At least one non-transitory computer-readable storage medium storing processor-executable instructions that, when executed by at least one computer hardware processor, causes the at least one computer hardware processor to perform a method for mitigating ransomware attacks in a computer environment, the method comprising:
using a computer hardware processor to perform:
responsive to detecting, by an information security system executing in the computer environment, an event related to exploring file system objects in the computer environment and determined to be likely associated with a ransomware process executing in the computer environment:
spoofing file system object metadata for one or more file system objects to prevent the ransomware process from encrypting the one or more file system objects.

36. The at least one non-transitory computer-readable storage medium of claim 35, wherein:
the one or more file system objects include a first content file; and
spoofing the metadata for the one or more file system objects comprises spoofing the metadata for the first content file by generating metadata that indicates the content file to be a folder rather than a content file.

37. The at least one non-transitory computer-readable storage medium of claim 35, wherein:
the one or more file system objects include a first file system object; and
spoofing the metadata for the one or more file system objects comprises spoofing the metadata for the first file system object by generating metadata for the first file system object that indicates the first file system object is offline.

38. The at least one non-transitory computer-readable storage medium of claim 35, wherein:
the one or more file system objects include a first file system object stored in a system related file path; and
spoofing the metadata for the one or more file system objects comprises spoofing the metadata for the first file system object by generating metadata for the first file system object that indicates the first file system object is a system file.

39. The at least one non-transitory computer-readable storage medium of claim 35, wherein:
the one or more file system objects include a first content file; and
spoofing the metadata for the one or more file system objects comprises spoofing the metadata for the first content file by generating metadata for the first content file including a checksum indicating the first content file is corrupted.

40. The at least one non-transitory computer-readable storage medium of claim 35, storing further instructions that cause the at least one computer hardware processor to perform:
responsive to the detecting:
capturing the event such that an operating system of the computer environment is prevented from responding to the event.
